(19) United States
(12) Patent Application Publication
(10) Pub. No.: US 2005/0109940 A1
(43) Pub. Date: May 26, 2005

(54) Radiation sensor

(76) Inventor: William N. Carr, Montclair, NJ (US)

Correspondence Address: William N. Carr, 251 South Mountain Ave., Montclair, NJ, 07042, US

(21) Appl. No.: 10/720,062

(22) Filed: Nov. 25, 2003

(51) Int. Cl. G01J 5/20

(52) U.S. Cl. 250/338.4; 250/332

(57) ABSTRACT

A radiation sensor utilizing a single crystal semiconductor pyro-optical film to modulate a photonic carrier beam with energy in excess of the bandgap of the semiconductor for the purpose of detecting a first source of radiation. Specific implementations described here include a thin film of single crystal semiconductor made part of a suspended microplatform thermally isolated above an underlying substrate. The first source of low level radiation incident upon the microplatform and partially absorbed therein causes an incremental heating of the pyro-optical film. A second source of radiation comprised of a photonic carrier beam is incident on said microplatform and exits by reflectivity means or transmission means and is modulated by the pyro-optical effect with incremental heating of the platform and film. A detector or array of detectors monitors the intensity of the photonic carrier beam exiting the microplatform and thereby provides a sensitive means of monitoring the amplitude of the low level radiation.

### TECHNICAL FIELD OF THE INVENTION

This invention relates generally to the thermal sensing of low-level radiation comprised of infrared or millimeter wavelengths and more particularly to a single-crystal pyro-optical pixel structure with application as a focal plane array. This invention is a sensor for low level incident radiation using a highly sensitive thermal thin film structure and a method of image conversion using a MEMS plane. In its embodiment including an array of micromechanical pixels, a thermal image obtained typically from infrared wavelengths is interrogated using an optical carrier beam and read out with conventional CCD or CMOS silicon imagers.

### BACKGROUND OF THE INVENTION

Thermal-sensing systems typically use a pixel that is highly sensitive to temperature differentials. This minute temperature differential is read out into an electrical signal using a modulated optical carrier beam as an intermediate interrogator. The basic components for a thermal imaging system generally include optics for collecting and focusing the incident irradiation from a scene onto an imaging focal plane.

A chopper is often included in a thermal imaging system to produce a constant background radiance used as a reference signal. The electronic processing portion of a thermal imaging system including a chopper will subtract the reference signal from the total radiance signal to produce an unbiased output signal with a reduced background noise level.

The concept of using a pyro-optical material as a sensor to detect radiation by modulating the polarization of a carrier beam was disclosed by Elliott in U.S. Pat. No. 4,594,507. The Elliott patent describes a system with an optical carrier source 1 and an external radiation source illuminating a pyro-optical pixel with a photodetector to monitor the amplitude of a carrier source modulated by the transmissivity of a pyro-optical pixel. A low level radiation source is focused onto the pyro-optical plane through a refractory lens. Elliott describes the use of optically active liquid crystal cells and a polarization analyzer adjusted to near extinction as comprising the thermally-sensitive pyro-optical element. The liquid crystal cells rotate the polarization transmission vector of the carrier beam as a result of minute changes in temperature from absorption of the incident low level radiation. The present invention teaches an improved sensor in which the number of critical optical films is reduced to a single film of single crystal semiconductor. The present invention amplitude modulation of the carrier beam controlled by band-to-band optical absorption in a crystalline semiconductor pyro-optical film instead of polarization-modulation. The system detailed by Elliott operates within an oven typically at 28 deg C and no mention is made for heaters within each individual pixel. The system is specified only for imaging infrared irradiation. Individual detail pixel structures are not described. Performance-enhancing interferometric structures are not mentioned.

Hanson in U.S. Pat. No. 5,512,748 discloses an imaging system containing a focal plane array in which a visible or near-infrared source is used to transfer an image from a transmissivity-modulated film layer onto a structurally connected integrated circuit photodetector. The photodetector integrated into the substrate generates a bias signal representing the total radiance imaged from a remote low-level scene. A thermal sensor is described which contains infrared-sensitive material supported by two bifurcated support arms and nonflexing posts to maintain this film layer above the substrate with a gap therebetween. The thickness of the infrared-sensitive material is not mentioned except to note that it is preferably “very thin to enhance it's response to incident infrared radiation and to allow transmission of electromagnetic energy therethrough” (col. 7, line 8) without mention of internal interferometric characteristics. The vacuum gap under the sensitive film is said to preferably correspond to ¼ wavelength of the selected infrared incident radiation wavelength to provide maximum reflection of the infrared from the semiconductor substrate to the infrared-sensitive film. Hanson does not disclose or claim the use of electrical heater elements or any means of temperature control within or without the infrared sensitive pixel. Hanson does not mention modulation of the reflectivity of the carrier beam by the pyro-optical film. Hanson does not disclose an imager embodiment without a chopper in the path of the incident infrared beam. The present patent uses the unique structure of crystalline semiconductors for the pyro-optical film. The Hanson patent does not mention the crystalline pyro-optical semiconductors of the present invention but instead teaches the use of materials not available in thin film single crystalline form for pixels: barium strontium titanate, barium titanate, antimony sulfoiodide, lead titanate, and lead lanathanum zirconate titanate. The Hanson patent does not teach the use of SOI as a starting wafer for fabrication.

Owen in U.S. Pat. No. 6,087,661 describes a structure with electrically conducting tetherbeams forming a signal flow path for readout from a pyroelectric pixel material. The tetherbeams further provide a thermal isolation for the pyroelectric sensor microplatform. The Owen patent does not use an image conversion scheme, but instead teaches a bolometer in which the electrical resistance of a thermally-sensitive thermister is wired to a readout integrated circuit. There is no optical transfer of signal in the Owen patent.

Robillard in U.S. Pat. No. 4,751,387 describes an infrared imaging system comprising a pyro-optic film consisting of dichroic liquid crystal coated on a membrane with a means of polarized visible light illumination onto the crystal film. In addition a means for analyzing the polarization of the visible light carrier after reflection from or transmission through the crystal film is included in a system where the readout described is the human eye. Robillard does not disclose or claim any micromachined structures, thermal isolation structures, the use of partial vacuum, ovens, pixel heaters, or single crystalline semiconductor.

Cross in U.S. Pat. No. 4,994,672 describes an infrared imaging system including a sandwich structure of polarizing pyro-optic material formed over an optically transparent, thermally insulating foam such as silica aerogel. The reflectance (not transmission) of an interrogating light beam is modulated by the temperature of the material and is used to illuminate a pixel image onto a CCD. A container means is provided for enclosing the pyro-optical material and maintaining a stable temperature. The Cross system requires the use of polarized light in contrast to the present invention which does not utilize the polarization of light. Cross does not disclose the use of micromachined pixel structures, performance enhancing interferometric structures, vacuum conditions surrounding the pyro-optic material, or the use of SOI starting wafers for fabrication.

Tuck in U.S. Pat. No. 5,100,218 describes a specific thermal imaging system based on the thermal rotation of polarized light as it is modulated with transmission through a thermally-sensitive liquid crystal. The pyro-optical liquid crystal is separated from the optical source and photodetector by multiple lenses. Liquid crystal is the only pyro-optical material mentioned. Pyro-optical modulation means that do not utilize polarization are not disclosed. Tuck does not disclose any micromachined structures, interferometric structures, crystalline pyro-optical thin films, SOI starting wafers for fabrication, or any means of electrically heating individual pixels.

Carr in U.S. Pat. No. 6,091,050 describes a micromachined platform that elevates automatically and without continuing power requirement which has been used for implementing pixels in the present invention. The platform is elevated to a desired level as a result of design and manufacturing controls to create the desired gap between the pyro-optical film and the underlying substrate thereby providing a Fabry Perot interferometric means of enhancing the absorption of incident low-level radiation. The use of this process to permanently actuate a microplatform for an application within the fabrication overall process for the present invention is cited.

Carr and Sun in U.S. Pat. No. 5,781,331 describe a micromachined shutter array that when thermally actuated can serve as a means of gating or synchronously chopping the incoming low-level radiation. Readout electronics for detecting the biased signal and the reference signal and for subtracting the reference signal from the biased signal to obtain an unbiased signal representing radiance differences emitted by objects in the scene is typically implemented. This shutter is cited as one means of chopping the incident low level radiation to achieve synchronous detection and accompanying reduction of the total noise in the present invention.

Hanson et al in U.S. Pat. No. 5,486,698 describe an actuation means for periodic thermal coupling of a bolometer or ferroelectric sensing platform to a thermal reference substrate. This actuator operates by electrostatic force which is derived from an external voltage source and eliminates the need for an external mechanical chopper. This actuation scheme is not used in the present invention.

The present invention describes the use of single crystal pyro-optical films, the use of bonded semiconductor composite sandwich structures and image enhancement gain means which are each significant improvements over previous teachings for application in radiation detectors and low level radiation imaging systems. The uniqueness of the present invention relates to the materials, fabrication techniques and processes, and operational features of the physical plane and structures including and linked to the pyro-optical film. In each of the embodiments of the present invention the pyro-optical film is obtained by processing a starting wafer of semiconductor-on-insulator generally referred to as SOI.

### BRIEF DESCRIPTION OF THE DRAWINGS

In the drawings accompanying this specification:

FIG. 1 is a schematic of a transmissive converter including readout with control and based on thermal modulation of a MEMS plane containing a crystalline semiconductor film modulator.

FIG. 2 is a schematic of a reflecting converter including readout and control based on thermal modulation of a MEMS plane containing a crystalline semiconductor film modulator.

FIG. 3 is a representative plot of the transmissive modulated carrier beam as a function of the temperature of the crystalline semiconductor film modulator.

FIG. 4 illustrates the incident infrared and incident carrier beam and the modulated exit carrier beam.

FIG. 5 is the cross section of a pixel immediately prior to the wafer bonding process step which bonds an unpatterned SOI first wafer to a patterned substrate second wafer. The microplatform overlays the tetherbeams.

FIG. 6(a) is the top view of the pixel of FIG. 5 showing the topside patterned semiconductor crystalline film with four tetherbeams.

FIG. 6(b) is the cross section of the pixel of FIG. 5 following wafer bonding, additional lithographic patterning, and with the sacrificial films removed. An ROIC detector is shown in close proximity for the transmissive application.

FIG. 7(a) is the top view of a second embodiment heated pixel containing a semiconductor crystalline thin film serving as a pyro-optical modulator and also as an electrical heater.

FIG. 7(b) is the section view A-A′ of the pixel in FIG. 7(a).

FIG. 7(c) is the section view B-B′ of the pixel in FIG. 7(a).

FIG. 8 is the top view of an array of 4 radiation sensor pixels with process-elevated microplatforms.

### DETAILED DESCRIPTION OF THE INVENTION

The present invention is a radiation sensor which utilizes a crystalline pyro-optical thin film to modulate an optical carrier beam. The pyro-optical film absorbs radiation from a low level first source resulting in an incremental heating of the film A second source optical carrier beam is amplitude modulated by the change in reflectivity or transmissivity of the pyro-optical film. The modulated carrier beam is detected by a readout detector typically of silicon thereby providing a means of monitoring the intensity of the incident radiation from the first source. Six embodiments of this invention are described here. Each embodiment utilizes the unique features of a thin crystalline film that amplitude modulates an interrogating optical carrier beam. This invention utilizes bonded wafers including thin films of semiconductors typically referred to as semiconductor-on-insulator (SOI).

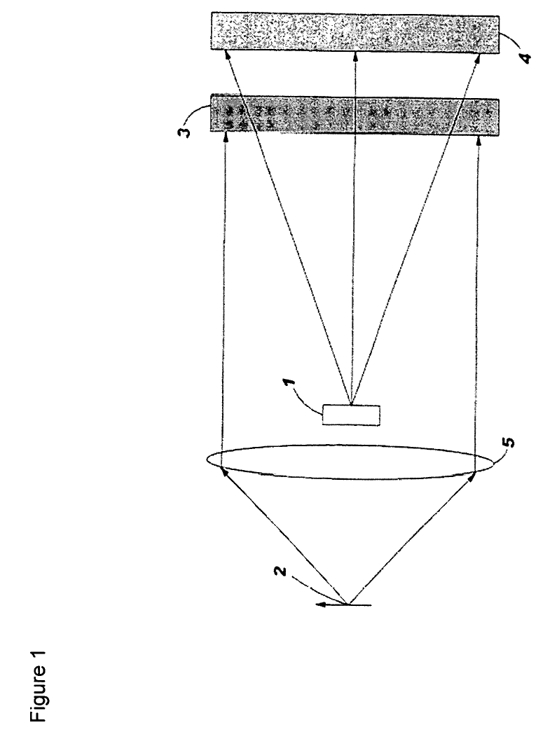

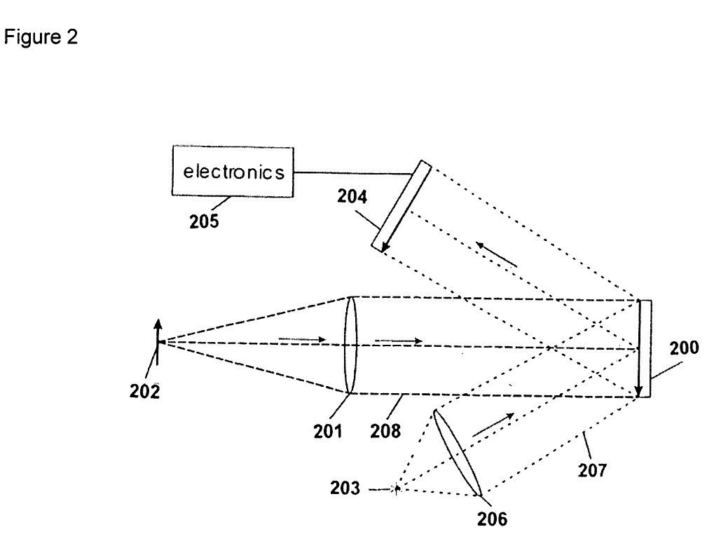

FIG. 1 is the cross section schematic of the present invention operated as a transmissive-type radiation sensor which can include imaging of a first source of radiation 2 onto a readout detector 4. Lens 5 focusses the first source of radiation onto an image plane 3 containing the pyro-optical film. For imaging, the detector 4 is a CMOS or CCD array readout integrated circuit ROIC. For single pixel sensing, the detector 4 may be an avalanche photodiode or PIN type of drift diode. The second source of radiation from 1 is modulated by the pyro-optical film plane 3 and detected by ROIC 4. The present invention may also be operated by modulating the reflection from the structure surrounding and including the pyro-optical film as shown in FIG. 2. FIG. 2 is a cross section schematic of a reflective system in which a first source of low level radiation is focussed onto the pyro-optical plane 200 by means of lens 201. The second source of radiation is an optical carrier beam reflection-modulated by the pixel structure 200 and terminated in the detector 204. The optical carrier beam is used as an interrogation means to monitor the temperature of the pyro-optical thin film. For single pixel applications, the lens 206 serves to collimate the carrier beam which is modulated by the pyro-optical plane 200 and detected at 204. For imaging applications, lens 206 serves to collimate the carrier beam which transfers a modulated image pattern from the pyro-optical plane 200 to respective points on the ROIC 204. The readout electronics 205 may be optionally contained within the readout ROIC. The readout electronics serve to format images for database storage, display, and telecommunications.

The present invention contains a pyro-optical film that is micromachined into structures that enhance the absorption of and sensitivity to the incident first source of radiation. The pyro-optical film is contained within a microplatform that is thermally isolated from a substrate. The pixel is typically maintained in a vacuum to reduce the thermal cooling through gas and convection heat transfer to and from the microplatform and thereby thermally isolating the microplatform from a substrate. Each embodiment of the pyro-optical structures of the present invention contain a crystalline film of silicon, silicon-germanium, germanium, gallium arsenide, indium arsenide, and other semiconductor films that modulate the amplitude of the interrogating optical carrier beam. The pyro-optical films typically of less than 1 micrometer in thickness exhibit adequate thermal modulation of the carrier beam reflected or transmitted with respect to the microplatform and surrounding structures. The transmissive sensor configuration of FIG. 1 requires that the structure 3 be adequately transparent to the optical carrier beam to propagate the carrier beam through for terminating in the detector. The reflective sensor configuration of FIG. 2 requires that the surface structures of 200 be adequately reflective at the wavelengths of the carrier beam.

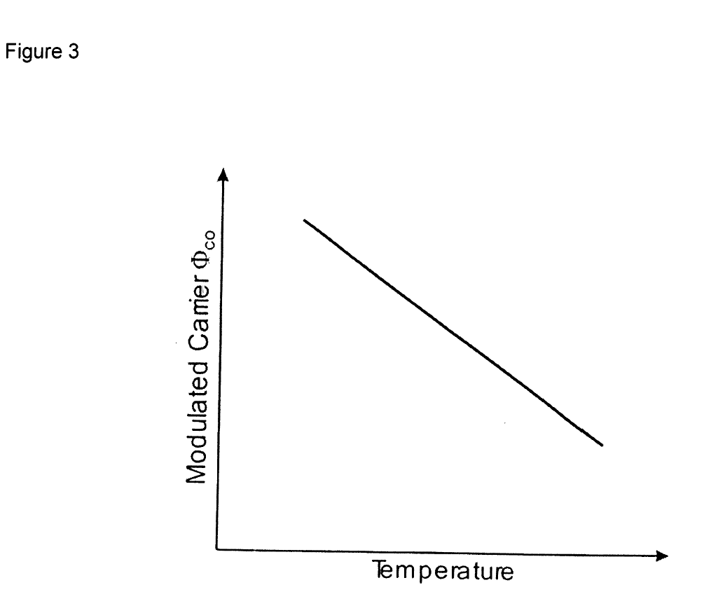

FIG. 3 shows the transfer function of a typical crystalline pyro-optical film for transmissivity of an optical carrier beam. The change in the energy band structure of semiconductor single crystal materials results in an increase in the coefficient of absorption at optical carrier wavelengths with increasing temperature. The hysteresis of this optical transfer characteristic is negligible as shown in FIG. 3 and therefore different from what is often observed in applications of typical noncrystalline pyro-optical films such as vanadium oxide or barium strontium titanate. In the embodiments of the present invention, modulation in the described reflectivity-mode of FIG. 2 result from a configuration where the pyro-optical film is positioned adjacent to a reflector which causes a double-pass of the optical carrier beam through the pyro-optical film. In contrast, for a first order model, the modulation effect observed in transmission structures used in the FIG. 1 example accrues from a single pass of the optical beam through the pyro-optical film. In addition to the single and double pass mentioned, there is a desirable additional modulation effect due to internal reflection within the pyro-optical film and is a function of the optical thickness of the pyro-optical film. The optimum thickness of the microplatform structure for maximum internal modulation index of the interrogating carrier beam is a complex function of the optical parameters within the microplatform and the thickness and of the films in the microplatform.

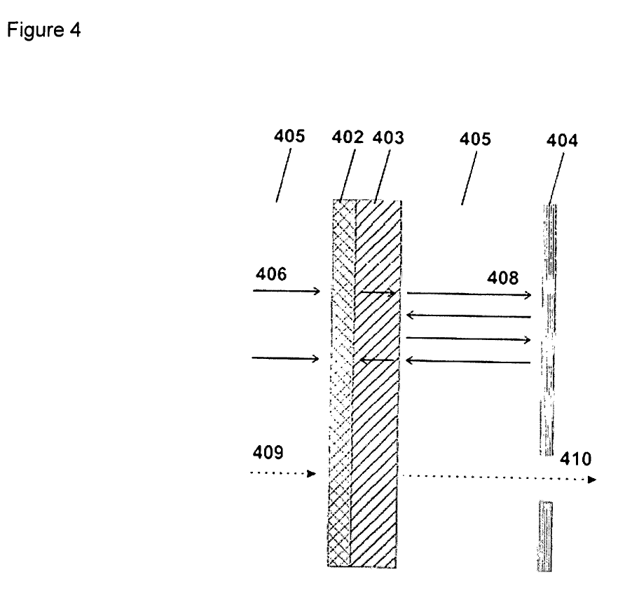

FIG. 4 is a cross section illustrating the operation of the modulator pixel containing the pyro-optical film 403 sandwiched with an additional structure 402. In the present invention the films 402 and 403 are derived from a starting SOI wafer. Incident radiation 409 from the second source is partially absorbed in the films 402 and 403 and continues as an exit beam 410 to the detector. The films 402 and 403 provide structural strength for the pixel which must remain stationary in place with tetherbeams. Film 402 partially absorbs the first source of radiation and thus increases the thermal sensitivity of the pixel to the incident first source. The films 402 and 403 are micromachined to form a microplatform structure and operated typically within a thermally-isolating vacuum space 405. The incident low level radiation 406 is partially absorbed in the pyro-optical film 403 and continues as beam 408. The structure 404 is a film or substrate surface which reflects the low level radiation 408 back into the microplatform films 402,403 and where 408,402,403 together form a Fabry-Perot etalon. The etalon serves to increase the intensity of the low level radiation 406 in the pyro-optical films 402 and 403 and thus increase the absorption efficiency for the incident low level radiation. The purpose of the etalon structure is to enhance the temperature rise of the film 403 which is interrogated by the second source of radiation 409 The etalon surfaces are ideally separated by a quarter wavelength of the low level radiation. The overall function of the FIG. 4 structure is to modulate the intensity of the exit carrier beam 410 as the temperature of the microplatform films 402,403 are increased with absorption of the incident low level radiation 406.

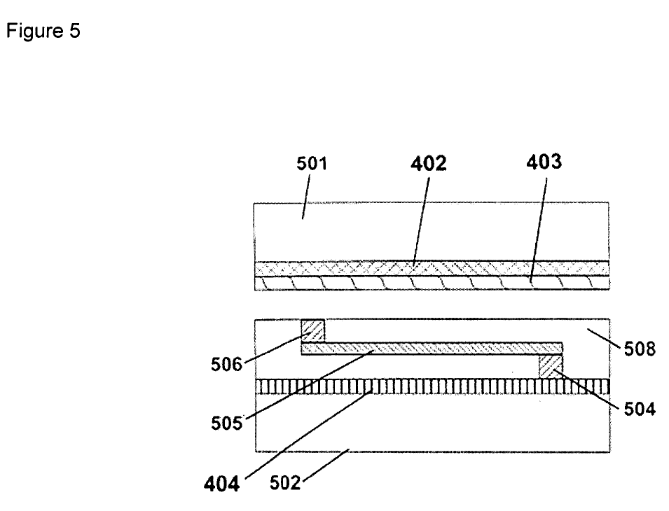

FIG. 5 illustrates an embodiment of a sensor pixel structure at an illustrative midpoint in the fabrication process. At this point in the fabrication process the SOI wafer with substrate 501 has not yet been bonded to the processed substrate 502. Fabrication of this embodiment begins when a substrate 502 is sputtered with a thin film of metal 404 typically aluminum or gold and patterned as appropriate. The substrate 502 is generally an area within a wafer of diameter 100 to 300 mm. Next the first film of sacrificial material 508 is processed in place and patterned with appropriate vias for the anchor 504. The sacrificial material is typically polyimide applied with a spin-on technique. Next, the anchor 504 of aluminum or silicon dioxide is deposited and patterned using a photoresist lift off process. The tetherbeam 505 is a thin film deposited and patterned also using a photoresist lift off process. As an option, the anchor 504 and tetherbeam can be created simultaneously with the anchor 504 using typically PECVD silicon dioxide. The tetherbeam 505 includes a patterned film of silicon dioxide deposited by low pressure chemical vapor deposition LPCVD. The tetherbeam 505 can also include a covering thin film of aluminum or tantalum silicide to provide self actuation of the tetherbeam upward thereby adjusting the height of the overlying platform at 406 according to the method taught by U.S. Pat. No. 6,091,050. For applications with infrared radiation as the low level radiation, a height of the microplatform of one quarter wavelength above the substrate is desirable for optimum absorption in the microplatform. The self-actuation is taught in detail in U.S. Pat. No. 6,091,050. A second layer of the sacrificial material 508 is processed in place and patterned with an appropriate via for anchor 506. Next the anchor of metal is sputtered as a thin film and patterned using the photoresist liftoff process. The metal 506 is aluminum-germanium, gold-germanium, or indium with a reduced eutectic temperature to facilitate alloy to silicon film 403. Separately, a silicon-on-insulator SOI wafer consisting of a substrate of silicon 501, a buried layer of silicon dioxide 402, and a thin film surface layer of crystalline silicon 403 is bonded to the exposed surfaces of the metal 506 and polymer 508. This process step alloys the pedestal 506 to the film 403. The structure at this point of the process is a composite wafer with the surfaces of 502 and silicon 501 exposed. Next, with the frontside surfaces of the composite wafer masked, a backside etch in typically potassium hydroxide is done to dissolve the silicon 501 and expose silicon dioxide 402. A patterning step is next completed to define the microplatform area. The pixel structure is released by immersion in oxygen plasma at low temperature as the sacrificial polymer is eliminated.

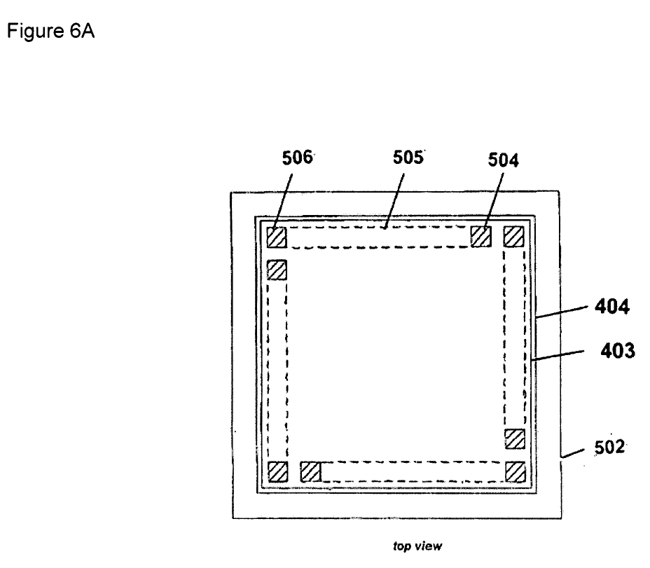

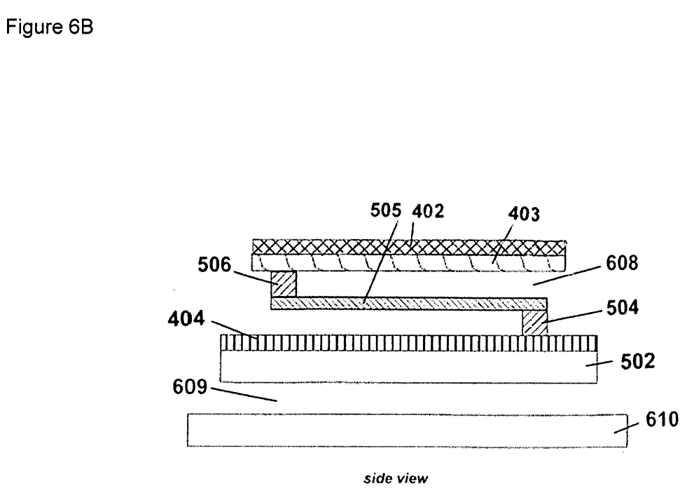

FIG. 6 shows views of the FIG. 5 pixel structure after processing to completion. In FIG. 6(a) and 6(b) the tetherbeam 505 supporting the microplatform structure 403 is connected with the anchors 504 and 506 identical as shown in FIG. 5. FIG. 6(b) is a side view showing the vacuum space 608 where the sacrificial material 508 of FIG. 5 has been removed with the plasma etch. The finished structure shown in FIG. 6(b) defines two preferred embodiments. The first embodiment shown in cross section in FIG. 6(b) obtains when the reflector 404 is not patterned and the incident second radiation is reflected from the film 404 to provide two optical passes through the modulating pyro-optical film 403 prior to exiting the pixel structure. The pixel described in FIG. 5 and FIG. 6 can be extended into an array format and used in an imaging application. The first preferred embodiment utilizes the pixel of FIG. 6(b) and the reflecting sensor scheme described in FIG. 2. A second preferred embodiment shown in FIG. 6(b) obtains when the reflector 404 is lithographically patterned with an opening to permit a portion of the incident optical radiation to exit through the substrate 502 and continue on to the detector 610. This second embodiment utilizes the pixel of FIG. 6(b) and the transmissive sensor scheme described in FIG. 1 where the optical carrier beam passes through the modulating pyro-optical film 403 with a single pass.

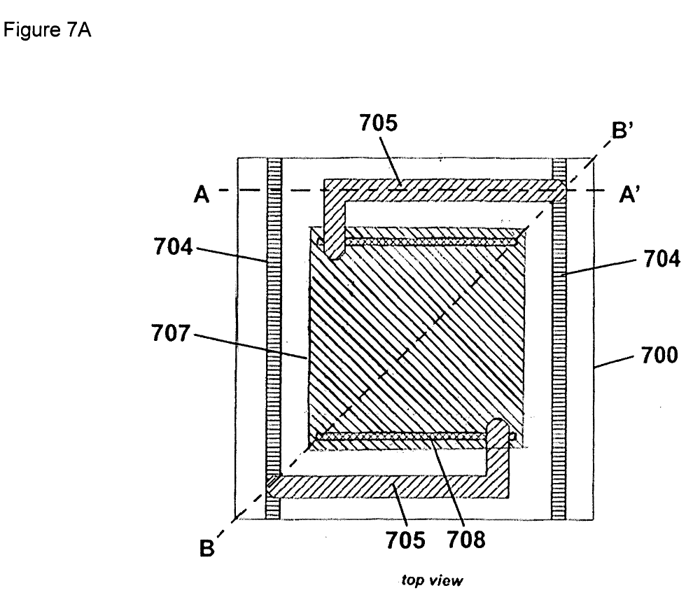

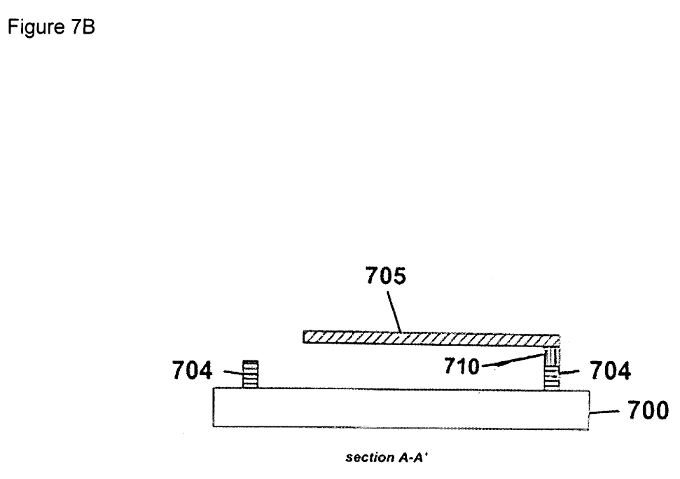

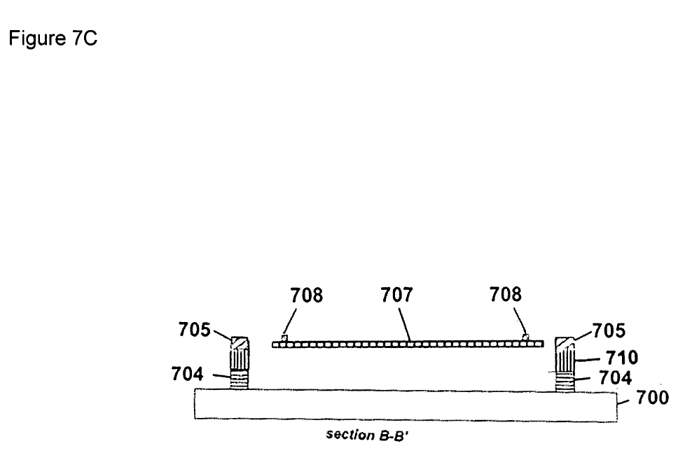

A third preferred embodiment described in FIG. 7 provides electro-thermal gain and is obtained by adding a heating element within each pixel with electrical bias to provide a feedback which enhances the incremental heating effect of the absorbed first source of low level radiation. A top view of the third embodiment is shown in FIG. 7(a). The side view sections A-A′ and B-B′ are shown in FIGS. 7(b) and 7(c), respectively. Fabrication of this preferred embodiment begins with patterning a metal 704 deposited on a substrate 700. Next, a uniform film of sacrificial polyimide is applied over the entire surface of the patterned metal 704 and substrate 700. A contact area is lithographically patterned into the polyimide to define via for contact metal 710 with the bus metal interconnect 704. The metal 710 is aluminum-germanium, gold-germanium, or indium with a reduced eutectic temperature to facilitate alloy to the overlying semiconductor film to be bonded. Next, an SOI wafer is bonded with the thin semiconductor film against the topside surface of the polyimide. The polyimide bonding process is accomplished using a standard wafer bonder at a temperature below the critical point of the specific polyimide used. Next, with the frontside surfaces of the composite wafer masked, a backside etch in typically potassium hydroxide is done to dissolve the silicon backing of the bonded SOI and expose silicon dioxide as was done in the first embodiment. The silicon dioxide-single crystal semiconductor film is now the topmost film of the structure of interest. The topside film silicon dioxide film is patterned to define a contact groove for metal contact 708. The topside films of silicon dioxide and crystalline semiconductor are next both lithographically patterned to obtain the microplatform 707. A metallic or conducting film typically aluminum is sputtered over the topside and patterned to obtain an ohmic connection 708 to the crystalline semiconductor film. A tetherbeam 705 is deposited overall and patterned to form the structural tetherbeam 705. The tetherbeam also serves as an electrical connection between the electrical busses 704 and the microplatform. The tetherbeam 705 is typically patterned as a flash of conducting film tantalum silicide or aluminum and covered with a structural film of LPCVD silicon dioxide. There is a low resistance electrical connection from the busses 704 to the semiconductor in the microplatform. The fabrication of the pixel is completed by immersing the structure in an oxygen plasma to remove the polyimide film and release the microplatform. In the fully processed pixel, the microplatform 707 is held in place only by the structural tetherbeams 705 which also provide the thermal isolation from the substrate 700. The third preferred embodiment with a quartz or sapphire substrate 700 transparent to the carrier beam is operated in the transmission mode as shown in the radiation sensor scheme of FIG. 1. When a voltage is impressed between adjacent bus runs 704 the semiconductor film of the microplatform is incrementally heated. The semiconductor thin film has a negative temperature coefficient of resistance TCR. There are two sources of energy heating the microplatform: electrical and photonic. The crystalline semiconductor film in the microplatform serves as both an electrical heater and also as the absorber for low level incident radiation. An incremental increase in absorption of the low level radiation causes a first decrease in electrical resistance of the microplatform. This first decrease in electrical resistance of the microplatform driven with the voltage source is amplified by the further decrease in electrical resistance due to heating from the voltage source. The resulting effect is that the electrical source supplies power to cause a second further decrease in the electrical resistance of the microplatform The result is that the heating effect of the first source of radiation is amplified and the carrier beam modulation index is greater than would occur without the electrical heating. This effect is called electro-thermal gain. The magnitude of electro-thermal gain increases with the electrical power supplied to the microplatform.

When a heater film with a positive TCR is deposited and patterned as part of the microplatform the pixel is driven electrically from a current source instead of a voltage source to obtain the desired electro-thermal gain.

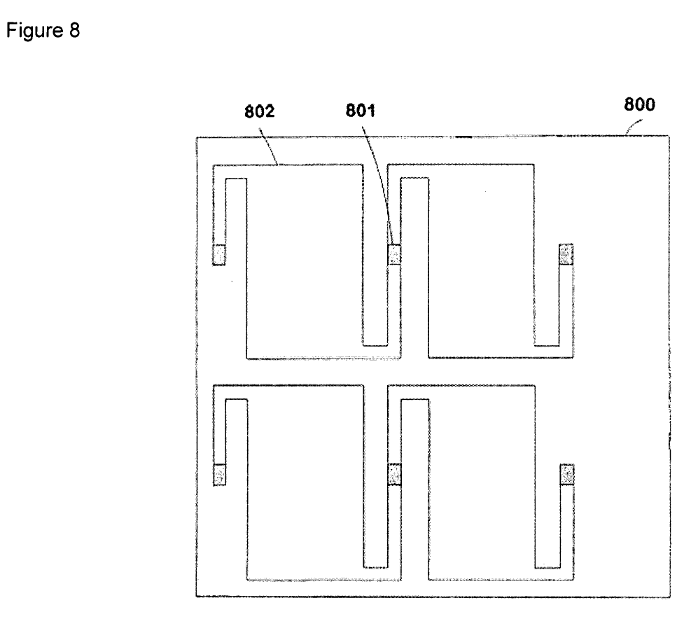

A fourth preferred embodiment shown in FIG. 8 is fabricated using a single wafer of SOI with a crystalline film. A flash of metal is sputtered at an elevated temperature to provide a bimorph structure for the tetherbeams. The topside film of the starting SOI wafer is first patterned to define the microplatform/tetherbeam layer 802. The tetherbeams are typically of width less than 2 micrometers to provide a low thermal conductivity and thermal isolation of the microplatform to match the typical sizes of the microplatform ranging from 20 to 300 micromicrometers on edge. The flash of metal is next lithographically removed overall except for covering the tetherbeams. Structural anchor contact holes through the crystalline film and the underlying oxide are used to expose the substrate. A structural anchor plug 801 is next sputtered or deposited and patterned lithographically to fill the contact hole. Next the silicon dioxide thin film is etched away using HF acid or by reactive ion etching selective to silicon dioxide. The silicon dioxide is thereby removed as a sacrificial layer and the microplatform with tetherbeams are suspended-above and thermally-isolated from the substrate. The bimorph tetherbeams will cause the microplatform to elevate naturally due to the permanent stresss caused by cooling of the wafer following the metal flash deposition. Incident low level radiation is focussed onto the plane of the microplatform 802. The optical carrier beam is used to interrogate the microplatform by transmissive or reflective means. The pixel structure of FIG. 8 is operated as a reflective pixel within the sensor of FIG. 2 when the SOI contains a semiconductor thin film and a semiconductor substrate. The fourth preferred embodiment operated in the reflective mode is typically a silicon thin film and a silicon substrate with a silicon dioxide layer therebetween. The desired reflector for the optical carrier beam is obtained from the large refractive index mismatch at the substrate-vacuum interface.

The pixel structure of FIG. 8 also describes a fifth preferred embodiment which operates in the transmissive mode. For this mode the starting wafer is a more complex SOI sandwich of silicon, silicon dioxide, and a substrate of silicon nitride/carbide. The starting wafer sandwich is obtained by ion implantation and subsequent bonding and delamination to form the sandwich structure using the hydrogenation-delamination process. This process for creating the starting material is similar to that described by Usenko in U.S. Pat. No. 6,387,829. The optical carrier beam adequately penetrates the gallium nitride or silicon carbide substrate to exit into the detector within the transmissive sensor scheme of FIG. 1.

The first source of radiation for each of the embodiments can be a low level source or sources derived from refractive or reflective optics imaging the remote source onto the plane of the pyro-optical film. A typical first source is radiation with wavelength greater than 6 microns including infrared and millimeter radiation. The first source of radiation can also be a radiation-emitting chemical reaction or biological process including chemiluminescence and bioluminescence. The second source of radiation can be an LED, filtered incandescent, or laser source or sources.

The detector is sensitive to the wavelength of the photonic carrier beam and is typically a silicon device. For imaging, a CCD or CMOS device is used. The dynamic range of the radiation sensor can be increased by cooling the detector readout.

In each embodiment the absorption of said second source causes an incremental heating of the pyro-optical film. The introduction of additional incremental heating due to absorption of the first source of radiation causes the absorption coefficient in the microplatform to increase further. Thus the overall effect of absorption of the first low level source of radiation is to cause a further incremental heating beyond that which would occur if the first and second sources of radiation were applied at different times. This enhanced incremental heating when absorption from both the first and second sources of radiation occurs simultaneously thereby provides a means of optical gain.

Each embodiment can be combined with an external chopper for the first source of incident radiation and operated as a synchronous sensor. The micromachined chopper of the type described in U.S. Pat. No. 5,781,311 is an example. The response of the detector is synchronously gated with the chopper during time windows of each amplitude modulation cycle of the second source to integrate the exiting photonic beam intensity during a first time window to define a reference level and separately during a second time window to define a biased level, with the second source comprised of different wavelengths during the first and second time windows, and with a detector readout which provides an unbiased level as the difference signal between the biased level and the reference level. This scheme provides a means of synchronous detection and effectively reduces noise originating within the radiation sensor.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

References Cited

1. Charles T. Elliott et al, “Thermal Imager”, U.S. Pat. No. 4,594,507 issued Jun. 10, 1986
2. Charles M. Hanson, “Thermal Imaging System With a Monolithic Focal Plane Array and Method”, U.S. Pat. No. 5,512,748 issued Apr. 30, 1996
3. Robert A. Owen et al, “Thermal Isolation of Monolithic Thermal Detector”, U.S. Pat. No. 6,087,661 issued Jul. 11, 2000
5. Jean J. A. Robillard, “Infrared Imaging System and Method”, U.S. Pat. No. 4,751,387 issued Jun. 14, 1988
6. Leslie E. Cross et al, “Pyro-optic Detector and Imager”, U.S. Pat. No. 4,994,672 issued Feb. 19, 1991
7. Amitava Gupta et al, “Broadband Optical Radiation Detector”, U.S. Pat. No. 4,262,198 issued Apr. 14, 1981
8. Michael J. Tuck et al, “Thermal Imaging Optical System”, U.S. Pat. No. 5,100,218 issued Mar. 31, 1992
10. William N. Carr, “Thermal Microplatform”, U.S. Pat. No. 6,091,050 issued Jul. 18, 2000.
11. Charles M. Hanson et al, “Thermal Imaging System with Integrated Thermal Chopper”, U.S. Pat. No. 5,486,698 issued Jan. 23, 1996.
12. A. Y. Usenko and W. N. Carr, “Separation Process for SIO Wafer Fabrication”, U.S. Pat. No. 6,387,829 issued May 14, 2002.

1. A radiation sensor comprising:
a microplatform including a crystalline semiconductor pyro-optical film tethered above and thermally isolated from a substrate;
a first source of low level radiation incident upon the microplatform and partially absorbed therein causing a first incremental heating of said film;
a second source of radiation comprised of a carrier beam incident on said pyro-optical film and exiting by reflection from or transmission through said film;
the intensity of the exiting carrier beam modulated by the temperature of said pyro-optical film; and
a detector monitoring the intensity of the photonic carrier beam exiting the microplatform thereby providing a means of monitoring the intensity of the first source.

2. The radiation sensor of claim 1 formed using a bonded sandwich of semiconductor-insulator-substrate as the starting material for manufacture.

3. The radiation sensor of claim 1 with an electrical means of enhancing the first incremental heating of said film by thermal feedback.

4. The radiation sensor of claim 1 with a photonic means of enhancing the first incremental heating of said film by thermal feedback

5. The radiation sensor of claim 3 with a resistive heater element integral to the microplatform and powered from a fixed amplitude source to increase the temperature to a quiescent level above that of the substrate where the first incremental heating causes a change in the electrical resistance of said heater and thereby a second incremental heating thereby providing a total incremental heating in excess of the first incremental heating.

6. The radiation sensor of claim 5 where the heater element exhibits a negative temperature coefficient of resistance and is powered from a voltage source or where the heater element exhibits a positive temperature coefficient of resistance and is powered from an electrical current source.

7. The radiation sensor of claim 4 where the absorption of said second source in the pyro-optical film increases with temperature and where the introduction of said first incremental heating causes the absorption of the second source to increase further causing a second incremental heating beyond that which would obtain if the first source of radiation were applied alone, and where thereby a means of optical gain is implemented.

8. The radiation sensor of claim 2 where the crystalline semiconductor pyro-optical film includes but is not limited to silicon, germanium, an alloy of silicon and germanium, gallium arsenide, or indium arsenide having an optical absorption or reflectivity characteristic which changes with temperature in the range of the wavelength range of the second radiation source.

9. The radiation sensor of claim 1 where the first and second sources each consist of one or more separate sources of radiation.

10. The radiation sensor of claim 1 where the means for achieving thermal isolation of the microplatform from said substrate includes operation in a vacuum and use of low thermal conductivity tetherbeams.

11. The structure of claim 1 where the substrate is a material transparent to the carrier beam including silicon dioxide.

12. The sensor of claim 1 where the response of the detector is synchronously gated during time windows of each amplitude modulation cycle of the second source to integrate the exiting photonic beam intensity during a first time window to define a reference level and separately during a second time window to define a biased level; with the second source comprised of different wavelengths during the first and second time windows; and with a detector readout which provides an unbiased level as the difference signal between the biased level and the reference level.

13. The radiation sensor of claim 1 where the detector is formed within said substrate comprising silicon or other semiconductor material adjacent to the overlying microplatform and positioned to receive radiation from the second source exiting the pyro-optical film.

14. The radiation sensor of claim 1 where the low level radiation incident on and partially absorbed in the microplatform is infrared radiation or millimeter wavelength radiation.

15. The radiation sensor of claim 1 where the low level radiation source incident on and partially absorbed in the microplatform is a radiation-emitting chemical reaction or biological process including chemiluminescence and bioluminescence.

16. The radiation sensor of claim 1 where the second radiation source is an ultraviolet, visible, or near infrared light source comprised of a light emitting diode, incandescent source, or a laser source emitting in the wavelength window modulated by the pyro-optical film and matched to the spectral sensitivity range of the detector.

17. The radiation sensor of claim 1 where the low level and high level sources of ra9. The radiation sensor of claim 1 configured as an array of microplatform pixels and optically aligned to a detector comprised of a charge-coupled diode CCD or CMOS imager array with signal conditioning circuitry providing an output signal formatted for driving external image displays or for buffering into external databases.

18. The radiation sensor of claim 1 with the low level radiation imaged onto the plane of an array of microplatforms and with the second source of radiation collimated or focussed such that the thermal image on said array is transferred to an array detector consisting of a charge-coupled diode CCD or CMOS imaging plane further comprising an imaging radiation sensor.

19. The sensor of claim 1 where the second radiation source, the pyro-optical film, and the detector are each comprised of silicon.

20. A method for producing an image of a scene using a thermal imaging system having a plurality of thermal sensors with elements sensitive to low level radiation mounted on or adjacent to an integrated circuit photonic detector comprising means of:
thermally isolating the sensitive element within each thermal sensor from the integrated circuit substrate to form an image representative of the low level radiation;
a single crystal pyro-optical film contained within each thermal sensor illuminated by a second source serving as a carrier beam;
a means of directing incident low level radiation from the scene onto the infrared sensitive elements to form a thermal image;
said carrier beam amplitude modulated by the temperature of the thermal sensor;
means of projecting the second source of radiation onto the thermal sensors and exiting to the adjacent surface of the integrated circuit detector;
means of providing photo-thermal or electro-thermal enhancement of the heating effect from the low level radiation; and
said detector for the second source radiation including an array of photosensors contained within said integrated circuit to provide a signal representative of the thermal image.

21. The thermal imaging system of claim 20 where the pyro-optical elements are formed from a bonded sandwich of semiconductor-insulator-substrate as the starting material for manufacture.
